(19) United States
(12) Patent Application Publication
(10) Pub. No.: US 2014/0006964 A1
(43) Pub. Date: Jan. 2, 2014

(54) System and Method for Storing Data Files in Personal Devices and a network

(71) Applicant: Yang Pan, Singapore (SG)

(72) Inventor: Yang Pan, Singapore (SG)

(21) Appl. No.: 14/014,352

(22) Filed: Aug. 30, 2013

Related U.S. Application Data
(63) Continuation-in-part of application No. 13/271,235, filed on Oct. 12, 2011.

(51) Int. Cl. G06F 3/0484

(52) U.S. Cl. CPC G06F 3/0484
USPC 715/738

(57) ABSTRACT

A system comprises a plurality of personal devices connectable to a network. Data files related to a user are stored in selected personal devices and in the network including in authorized websites. According to one embodiment, a user may select storage locations for a data file through a user interface displayed on one of the personal devices. According to another embodiment, the user may select the locations and lifetimes for the data file in the selected locations. A storage manager transfers, stores and removes data files in the personal devices and in the network according to the user's inputs.

### CROSS-REFERENCE TO RELATED APPLICATIONS

The present application is a continuation-in-part of the patent application Ser. No. 13/271,235 filed on Oct. 12, 2011.

### BACKGROUND

1. Field of Invention

This invention relates generally to a storage system. More specifically, the invention describes a system and method for storing data files in personal devices and a network.

2. Description of Prior Art

Cloud computing provides computation, software, data access, and storage services that do not require end-user knowledge of the physical location and configuration of the system that delivers the services. Cloud computing describes a new supplement, consumption, and delivery model for IT services based on Internet protocols, and it typically involves provisioning of dynamically scalable and often virtualized resources. It is a byproduct and consequence of the ease-of-access to remote computing sites provided by the Internet. Cloud computing providers deliver applications via the Internet, which are accessed from various personal devices, while the business software and data are stored on servers at a remote location. Most cloud computing infrastructures consist of services delivered through shared data-centers and appearing as a single point of access for consumers' computing needs. Data files can be stored in a cloud that is accessible by a personal device when the device is connected to the Internet.

Some data files must be stored in one or more personal devices. Some other data files may be stored either in the personal devices or in the cloud. A system and method for optimizing data file storage in the personal devices and in the cloud is clearly needed.

### SUMMARY OF THE INVENTION

It is an objective of the present invention to provide a system and method for storing data files in the personal devices and in a cloud in an optimized manner

It is another objective of the present invention to provide a user interface for a user to select the personal devices and/or the cloud to store the data file.

An exemplary system comprises multiple personal devices. The personal devices include but are not limited to personal computers, smart phones and personal media players. The personal devices are connectable to a network such as the Internet. Each of the personal devices further includes a data file storage system. The network or the “cloud” provides an almost unlimited data storage capacity. The data files may be stored in one or multiple servers in the cloud in an exemplary case.

According to one embodiment, a first level of user interface associated with a selected data file is displayed on a display window of a personal device after the user actuates an input device. The user interface includes a user selectable icon for selecting storage locations of the file. Upon the user's selection of the icon, the user selectable storage locations are displayed in a second display window. The locations include all personal devices and the cloud. The user may select one or more locations. A storage manager then transfers, stores and removes the data file in the personal devices and in the cloud according to user's selection. In one embodiment, the locations include only the personal devices and the cloud. In another embodiment, the locations further include websites such as a social network and a blog. In an exemplary case, the user may select a social network as one of the storage locations for the data file. The storage manager receives the user's login name and password and is able to upload the data file to the social network.

According to another embodiment, priorities for storing the data file in a location may also be displayed. The storage manager determines if the data file will actually be stored in a selected location based upon the available storage capacity of the device and the selected priority for storing the file in the device.

According to yet another embodiment, the user may select to store the data file in one or more selected locations for a predetermined period of time only. The storage manager will remove the data file when the lifetime is reached in a specific personal device or in the network.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram illustrating an exemplary system including personal devices and the cloud;

FIG. 2 is a schematic diagram illustrating a user interface for selecting the storage locations according to the first embodiment;

FIG. 3A is a schematic diagram illustrating a user interface for selecting the storage locations according to the second embodiment;

FIG. 3B is a table illustrating exemplarily an algorithm of the storage manager determining if a data file will actually be stored in a personal device based upon the priority indicator and the available storage capacity of the personal device;

FIG. 3C is schematic diagram illustrating a user interface for selecting the storage locations including an indicator of the storage capacity utilization for each of the personal devices;

FIG. 4 is a table illustrating that the storage manager is managing a status file for all data files and registered personal devices related to the user;

FIG. 5 is a flowchart illustrating the operation of the system according to the first embodiment;

FIG. 6 is a flowchart illustrating the operation of the system according to the second embodiment;

FIG. 7 is a flowchart illustrating the operation of the storage manager;

FIG. 8 is a flowchart illustrating the operation of the storage manager when a registered personal device is connected to the cloud;

FIG. 9 is a flowchart illustrating the operation of the storage manager when an unregistered personal device is connected to the cloud;

FIG. 10 is flow chart illustrating the operation of the system by employing the status file directly;

FIG. 11 is a schematic diagram illustrating another exemplary system including personal devices, a network storage means and a social network and a blog;

FIG. 12 is a schematic diagram illustrating a user interface for selecting the storage locations including a social network and a blog according to the third embodiment;

FIG. 13 is a schematic diagram illustrating in an exemplary manner that a personal photo is uploaded to a social network according to the third embodiment;

FIG. 14 is a schematic diagram illustrating a user interface for selecting the storage locations including lifetimes of the data file according to the fourth embodiment;

FIG. 15 is a flowchart illustrating the operation of the system according to the third embodiment;

FIG. 16 is a flowchart illustrating the operation of the system according to the fourth embodiment.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

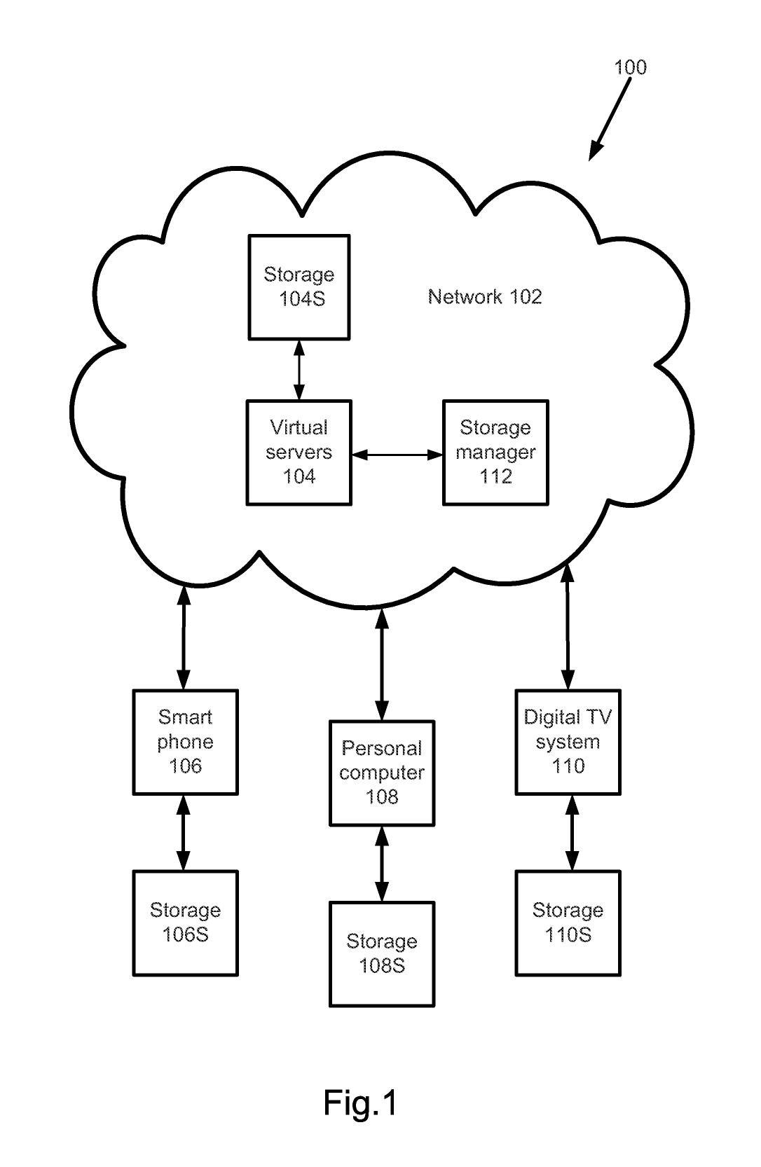

FIG. 1 is a schematic diagram illustrating an exemplary data storage system. The exemplary system 100 comprises a network or a cloud 102. The network 102 may be the Internet. Data files may be stored in the storage system 104S of virtual servers 104 that are generally hosted by third parties, rather than being hosted on dedicated servers. Hosting companies operate large data centers; and users who require their data files to be hosted buy or lease storage capacity.

The system 100 further comprises one or multiple personal devices. In an exemplary case, the personal devices include a smart phone 106 with a storage unit 106S, a personal computer 108 with a storage unit 108S and a digital TV system 110 with a storage unit 110S. The list of the personal devices is exemplary and many other personal devices such as automobile media delivery system, HiFi audio system, digital camera and portable media delivery system are alternatives or additions. The personal computer 108 may take various forms such as, for example, a desktop computer, a laptop computer and a tablet computer.

The personal devices are connectable to the network 102. Some of the personal devices may be connected to the network wirelessly. For example, the smart phone 106 may be connected to the network 102 via a telephony network or via a Wi-Fi. The personal computer 108 may be connected to the network 102 through a wired broadband infrastructure. Some of the personal devices may even be connected to the network 102 via a network gateway (not shown in the figure).

The system may further include a storage manager 112. The storage manager 112 may be located in the cloud 102 as illustrated in the figure. The storage manager 112 may also be located in one or multiple personal devices. The storage manager 112 manages locations where data files are stored according to a user's input through a user interface in a personal device. The locations include any one of the personal devices 106 to 110 and the cloud 102.

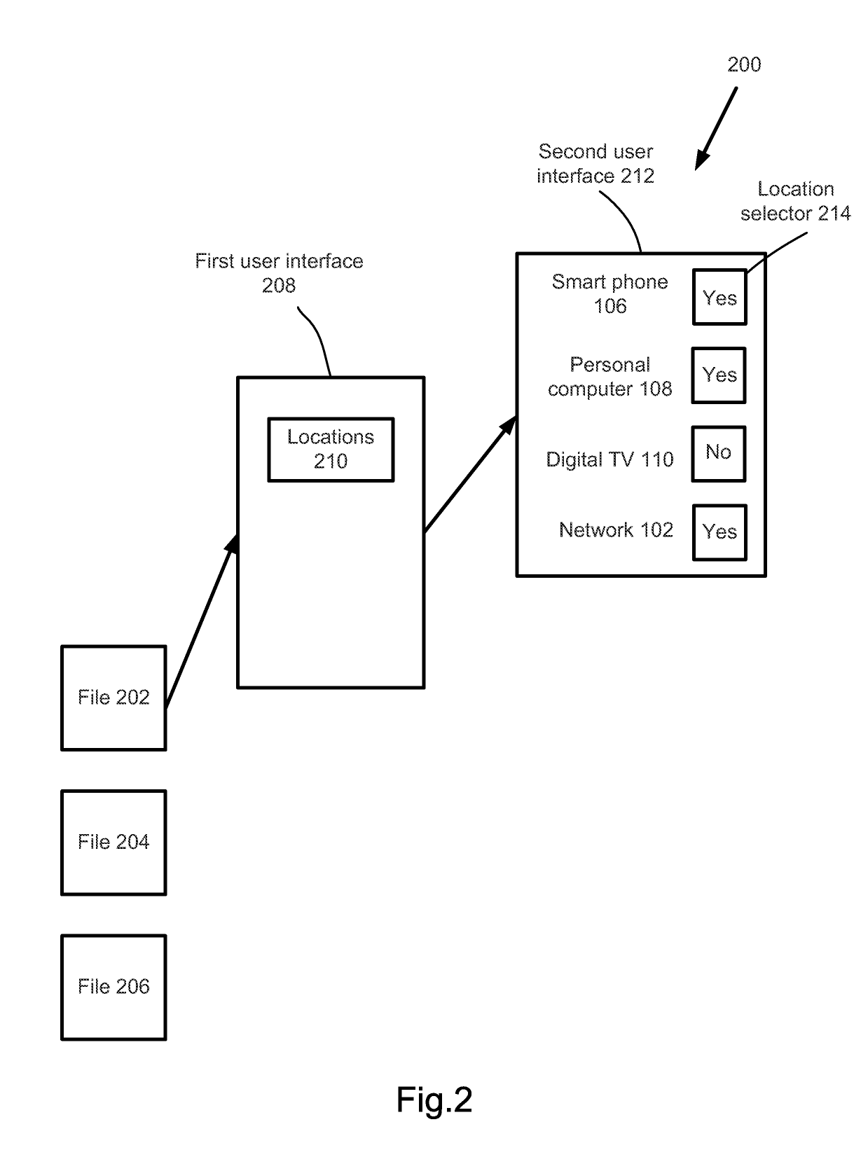

FIG. 2 is a schematic diagram illustrating a user interface 200 for selecting the storage locations according to the first embodiment. In an exemplary case, icons representing files: 202, 204 and 206 are displayed on a display window of a personal device. The first level user interface 208 associated with the file 202 is displayed after the user actuates an input device. In an exemplary case, the personal device is the personal computer 108. The user may move a cursor controlled by a mouse to point the file 202 and then right click the mouse to display the first level interface 208. The interface 208 further includes a user selectable icon 210. Upon the user's selection, the second level of the user interface 212 is displayed. The interface 212 may further include multiple user selectable storage locations for the data file 202. The user may select one or more locations through the location selector 214 and complete the operation. The implementation as illustrated in the figure is exemplary. The location selector 214 may be implemented in various forms as known in the art. Furthermore, the user selectable storage locations may be displayed directly in the first level of the user interface 208.

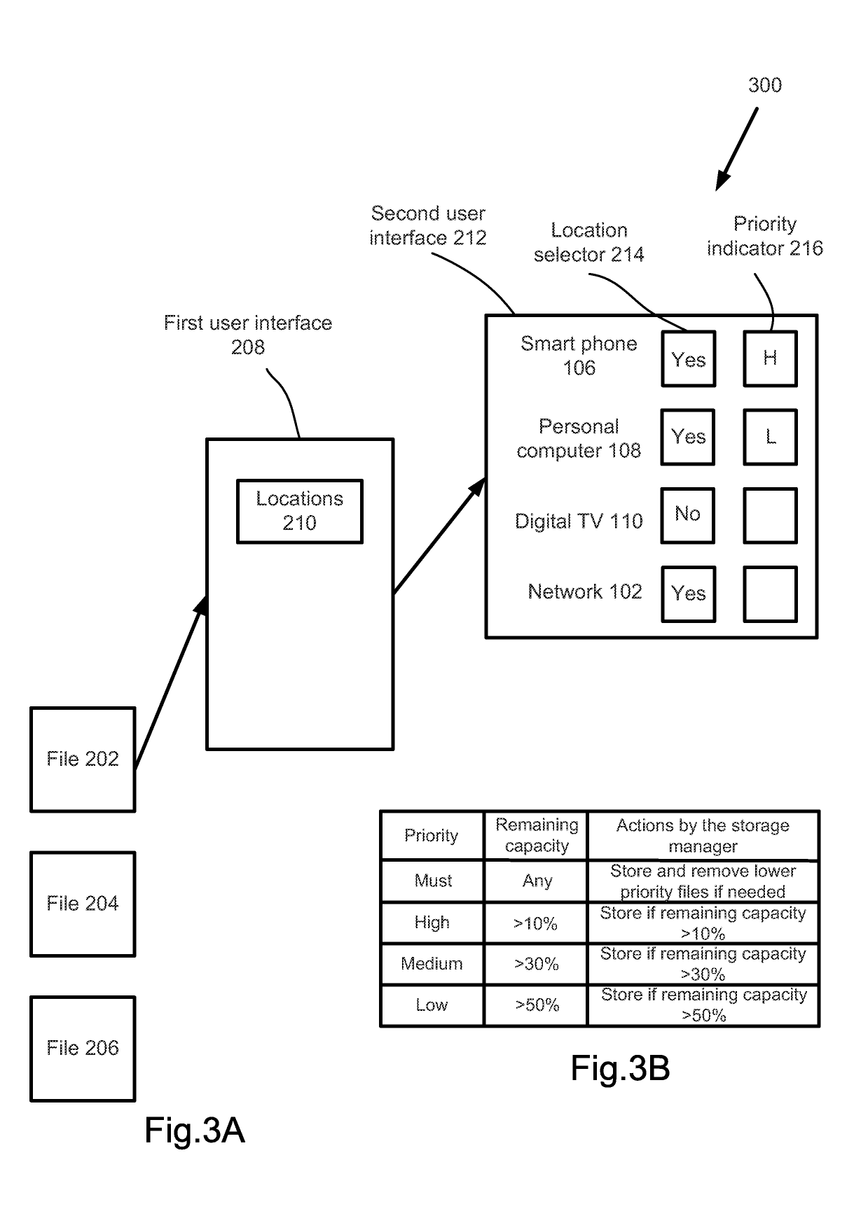

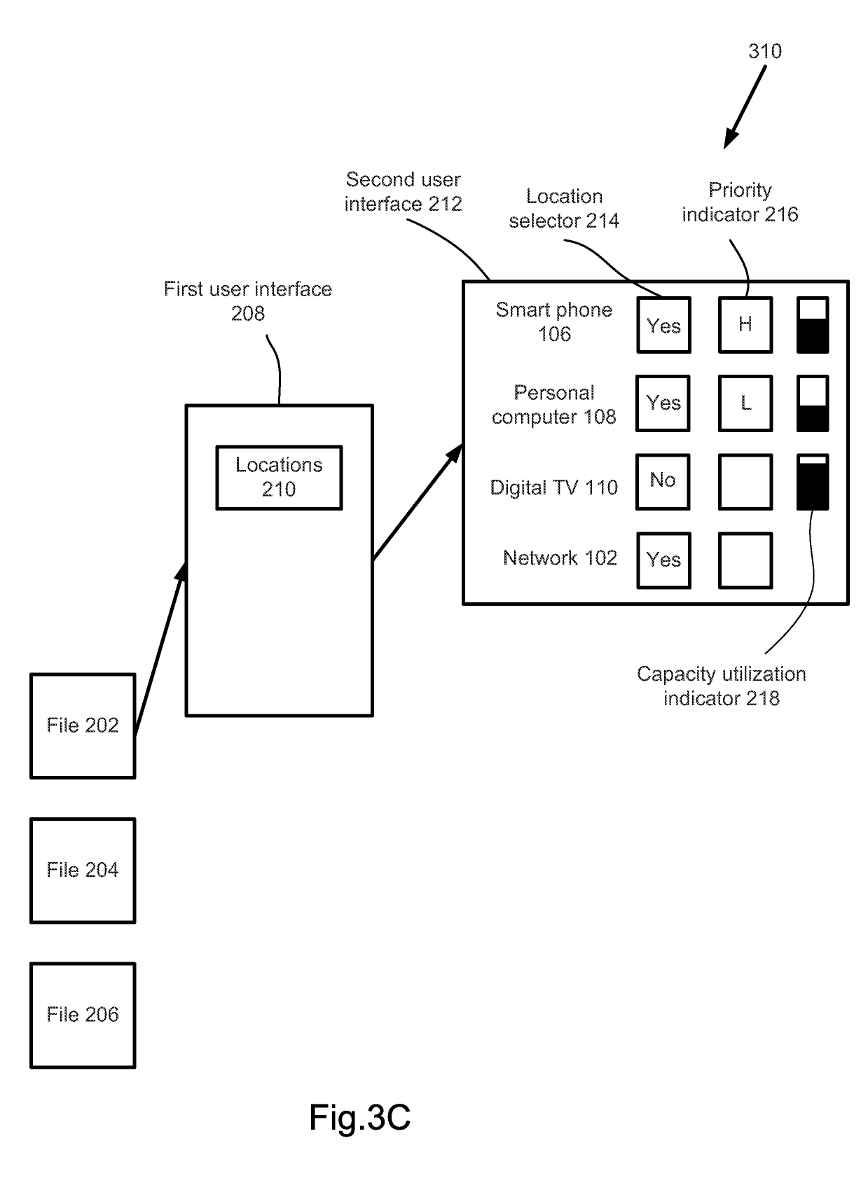

FIG. 3A is a schematic diagram illustrating a user interface 300 for selecting the storage locations according to the second embodiment. The second embodiment is identical to the first one for the first level of the user interface. The difference is on the second level of the user interface. An additional priority selector 216 is displayed on the second level of the user interface. According to one implementation, the priority for storing the data file 202 in a specific location (or device) may be classified as “must”, “high”, “medium” and “low”. According to another implementation, the priority may be changeable in a continued scale indicated by a mark on a ruler indicating different level of priorities. According to yet another implementation, the priority level may be indicated by different colors. For example, “red” may indicate higher priority than “blue”. The colors may be discretely selectable. The colors may be changeable in a continued manner. According to still another implementation, the priority may be selectable by different representative images.

According to one aspect of the embodiment, the data file to be stored in the network 102 may not be associated with a priority. The storage capacity in the cloud may be considered as infinite for a typical user of the system.

The user's selection may be transmitted to the storage manager 112 if the personal device is being connected to the network 102. If the device is not connected to the network 102 at the time that selections were made, the selections may be stored and be transmitted in a later time when the device and the network 102 are connected.

The storage manager 112 receives the user's selections and determines if the data file 202 will actually be stored in anyone of the selected personal devices according to the available storage capacity and the selected priority. An illustration of an exemplary algorithm is demonstrated in FIG. 3B.

If the selected priority for the data file 202 is a “must”, the data file will be stored in the personal device no matter what the available storage capacity is. The storage manager 112 will remove lower priority data files stored in the personal device to give room to store the file if the available storage capacity is insufficient.

If the selected priority for the data file 202 is anywhere from “high” to “low”, the data file will be stored if the available storage capacity in the personal device meets a predetermined criteria as illustrated exemplarily in FIG. 3B.

According to another implementation, if the available storage capacity is insufficient for storing higher priority data files, the storage manager may remove the lower priority data files to give room to store the higher priority data files. The removed files may be stored in the cloud 102.

FIG. 3C is schematic diagram illustrating a user interface for selecting the storage locations. Capacity utilization indicators of the storage capacity utilization for each of the personal devices are listed. The capacity utilization indicator 218 may be illustrated in a graphical manner as shown in the figure. The capacity utilization indicator 218 may also be a number. The capacity utilization indicator 218 may even be a combination of a graphics and a number. The capacity utilization indicator 218 may be updated in a predetermined frequency. The capacity utilization indicator 218 may also be updated whenever there is a change in the utilization of the storage capacity of the device.

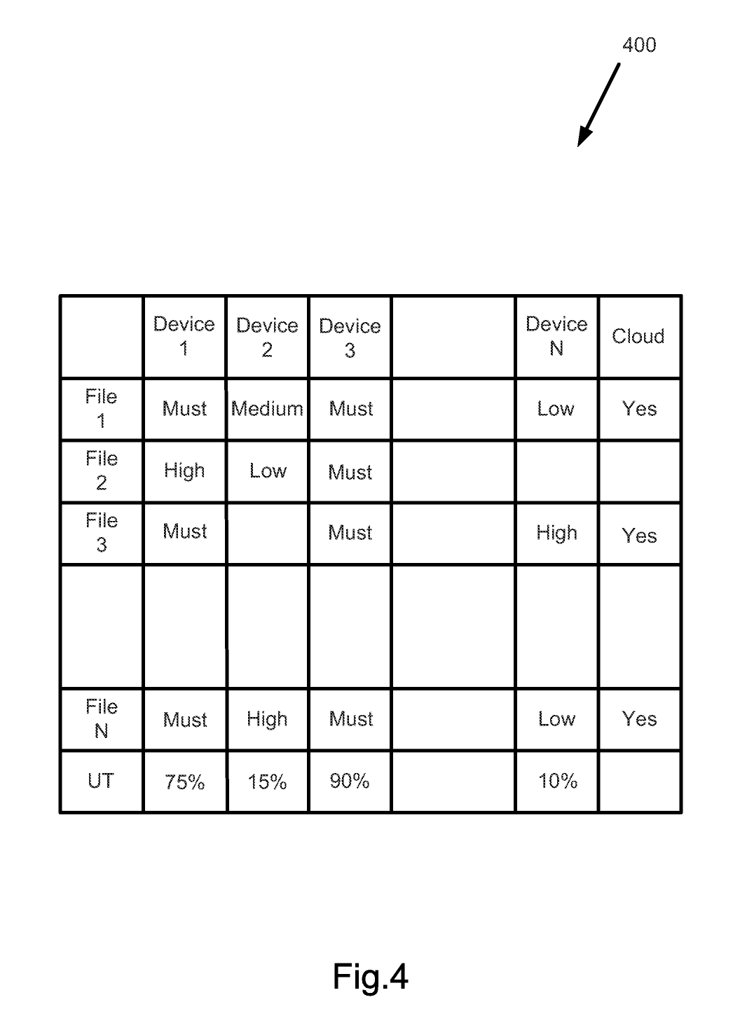

A user is typically associated with multiple personal devices and many data files. The data files may be store in one or several personal devices. The data files may also be stored in the cloud 102. FIG. 4 is a table illustrating in an exemplary manner that the storage manager 112 is managing a status file 400. The status file 400 is stored in the cloud 102 according to one implementation. The status file 400 is stored in one or several personal devices according to another implementation. The status file 400 may be updated regularly in a predetermined frequency. The status file 400 may also be updated whenever there is a change. The status file 400 may also be associated with another data file including metadata of at least some of the data files. The user may review the status file 400 and associated metadata through a user interface in a personal device. The user may review the status file in different manners such as, for example, review only the high priorities data files across all different devices, review all data files stored in the cloud 102 etc. The user may modify the status file 400 directly through the user interface. After the modification, the storage manager 112 will relocate the data files across different personal devices and the cloud 102.

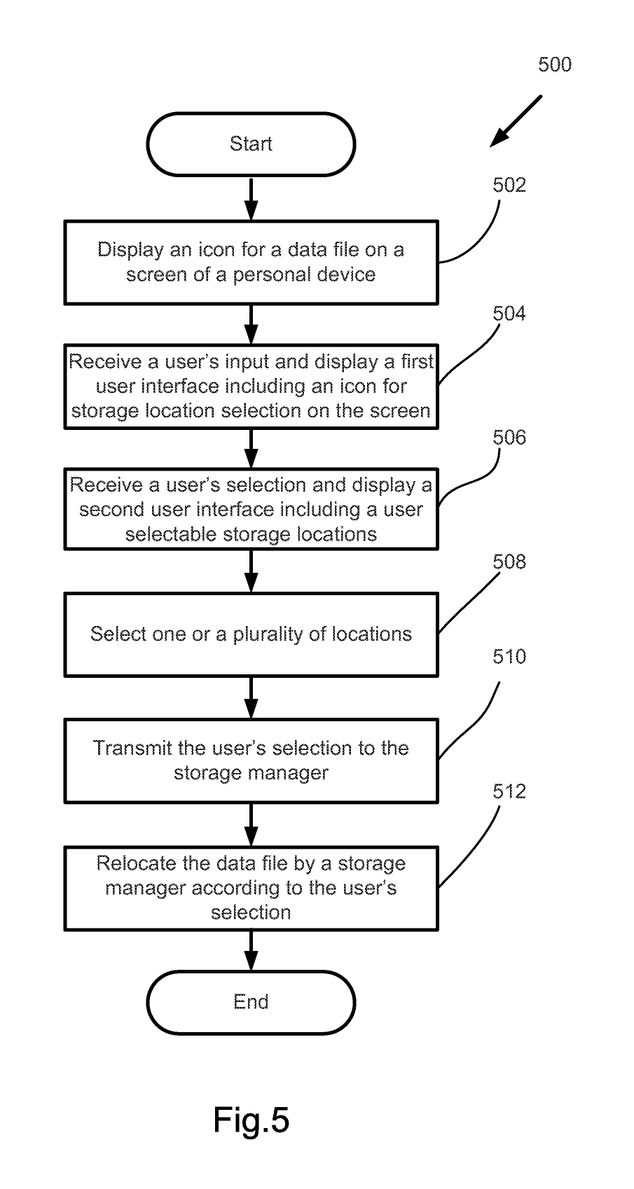

FIG. 5 is a flowchart illustrating the operation of the data storage system according to the first embodiment. Process 500 starts with step 502 that at least one icon for a data file is displayed on a display screen of a personal device. In step 504, the user's input action through an input device of the personal device is received. In an exemplary case, a mouse for a personal computer is right-clicked after a cursor is moved to point the data file. The first user interface 208 is displayed in a display window. The displayed first user interface 208 includes an icon 210 for selecting the storage locations of the data file. In step 506, the user's selection of the icon 210 is received by a processor of the personal device. The second user interface 212 including multiple user selectable storage locations is displayed. The locations include the personal devices and the cloud. In step 508, the user selects one or a plurality of locations through the input device. In step 510, the user's selection is transmitted to the storage manager 112. In step 512, the data file is then relocated among the personal devices and the cloud according to the user's selection. The status file 400 may be updated after the data file is relocated.

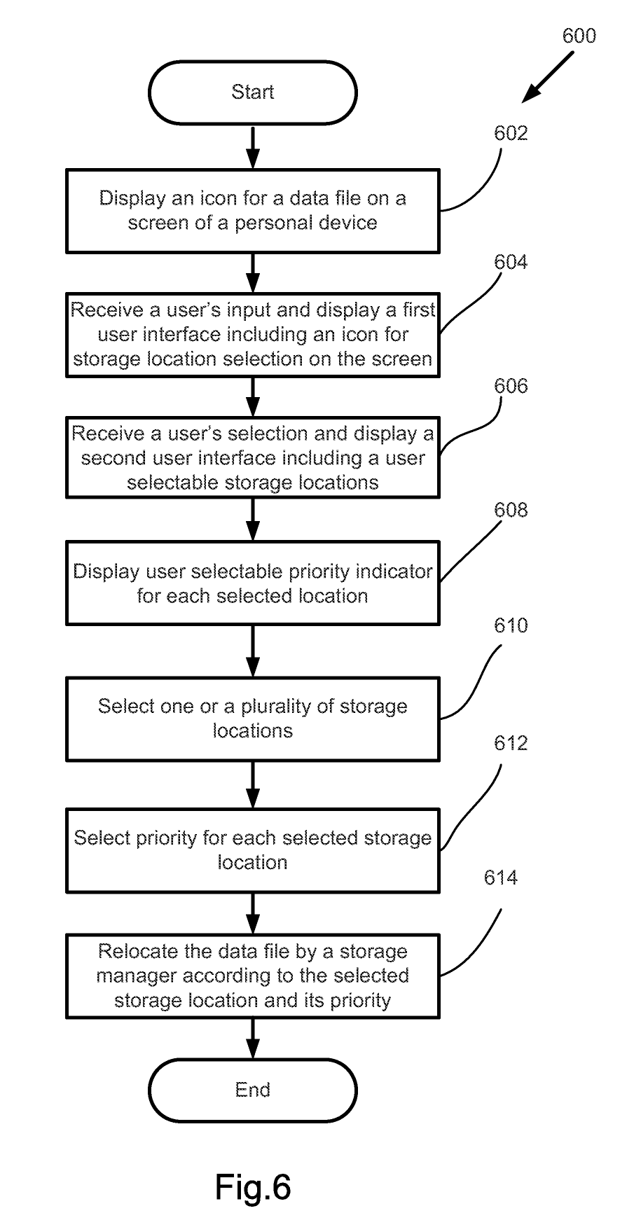

FIG. 6 is a flowchart illustrating the operation of the data storage system according to the second embodiment. Process 600 starts with step 602 that at least one icon for a data file is displayed on a display screen of a personal device. In step 604, the user's input action through an input device of the personal device is received. In an exemplary case, a mouse for a personal computer is right-clicked after a cursor is moved to point the data file. The first user interface 208 is displayed in a display window. The displayed first user interface 208 includes an icon 210 for selecting the storage locations of the data file. In step 506, the user's selection of the icon 210 is received by a processor of the personal device. The second user interface 212 including multiple user selectable storage locations is displayed. The locations include the personal devices and the cloud. In step 608, a user selectable priority indicator associated with each personal device is displayed. In step 610, one or a plurality of storage locations are selected by the user through the user input device. In step 612, the associated priority for each device to store the data file is selected. In step 614, the user's selection is transmitted to the storage manager 112 and the data file is then relocated among the personal devices and the cloud according to the user's selection. The status file 400 may be updated after the data file is relocated.

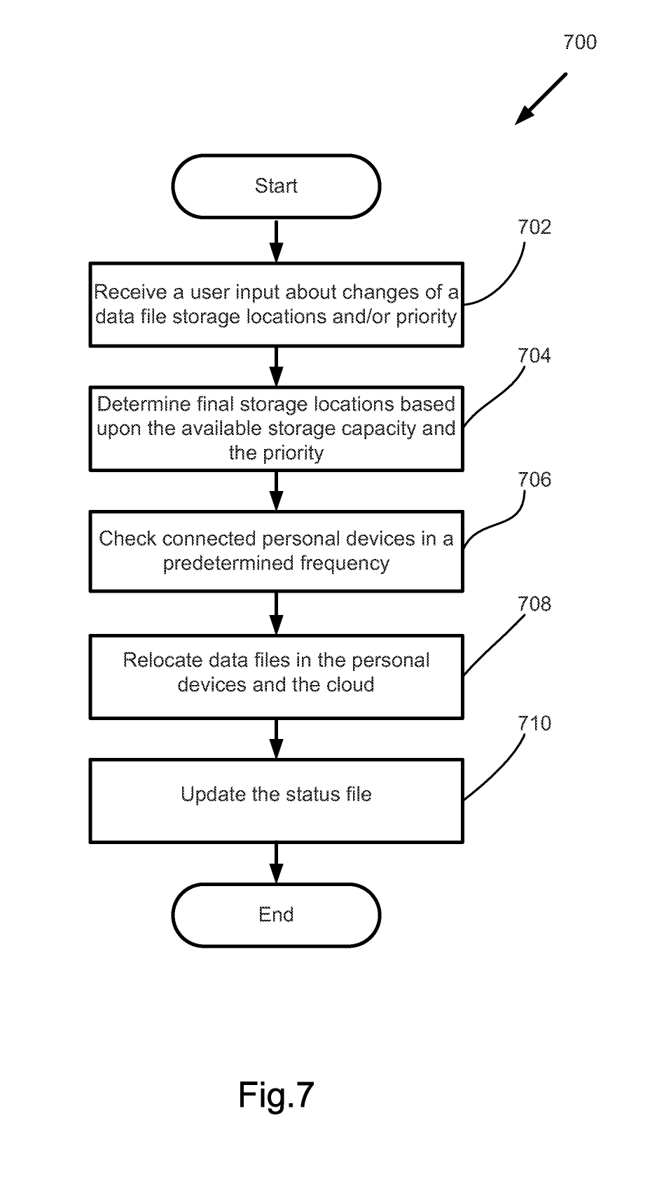

FIG. 7 is a flowchart illustrating the operation of the storage manager 112. Process 700 starts with step 702 that the changes about data file storage locations and priorities are received by a processor of the personal device. In step 704, the final storage locations are determined based upon the selected priority and the available storage capacity of the personal devices. The storage manager 112 checks which personal devices are connected to the network 102 in step 706. The data file is then relocated among the connected personal devices and/or the cloud in step 708. The status file 400 is updated in step 710. If some of the personal devices are not connected at the moment of checking, the data file will be transferred, stored or removed in the devices whenever they are connected according to the updated status file 400.

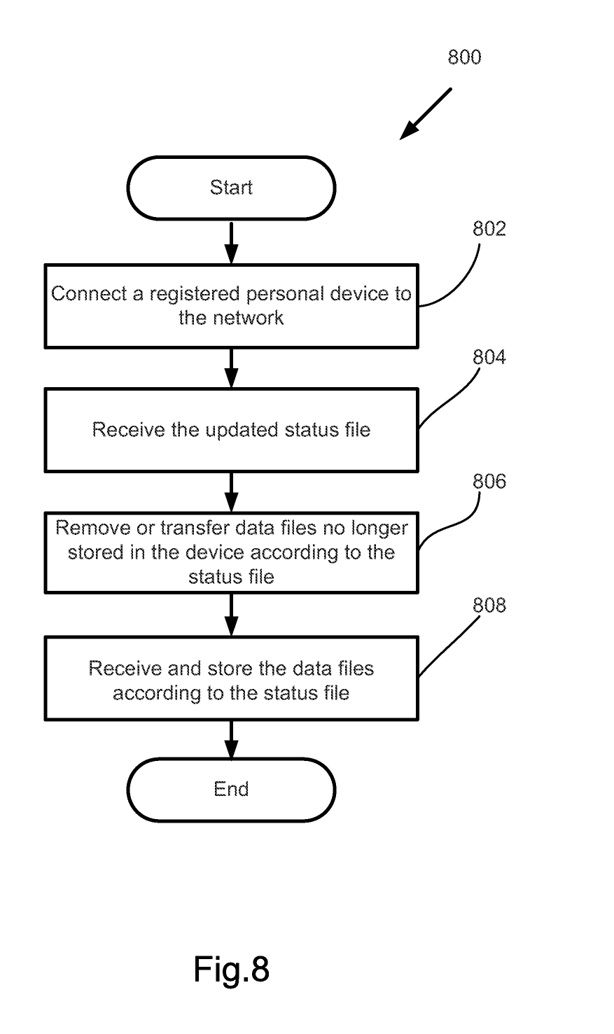

FIG. 8 is a flowchart illustrating the operation of the storage manager 112 when a registered personal device is connected to the cloud 102. Process 800 starts with step 802 that the registered device is connected to the cloud 102. According to one implementation, the updated status file 400 is received by the personal device in step 804. In step 806, the data files that are no longer to be stored in the personal devices are removed or transferred to other devices or to the cloud 102. In step 808, the data files that are required to be stored in the personal device are received and stored.

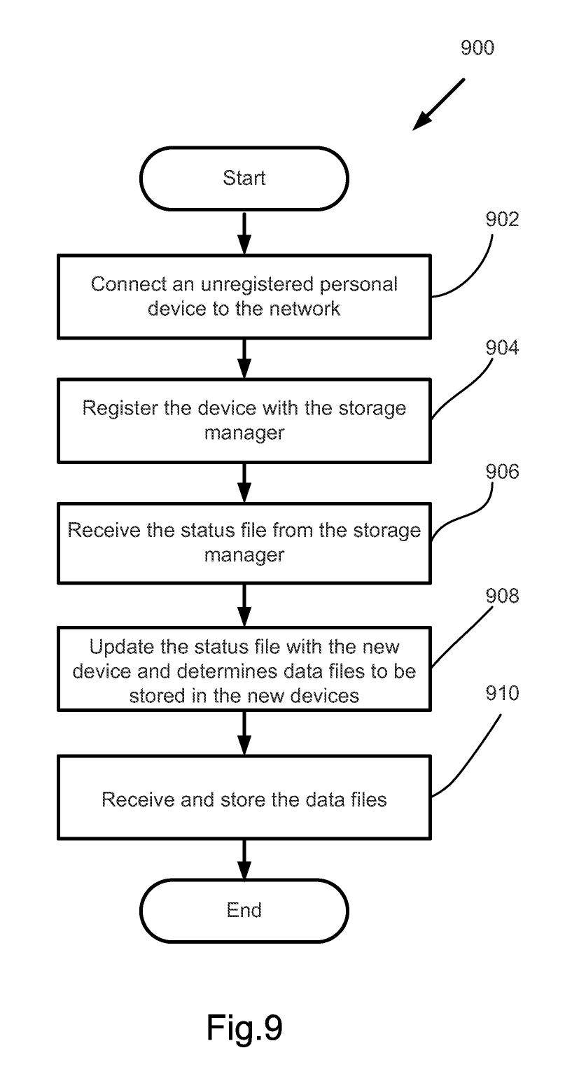

FIG. 9 is a flowchart illustrating the operation of the storage manager 112 when an unregistered personal device is connected to the cloud 102. Process 900 starts with step 902 that an unregistered device is connected to the cloud 102. The device is registered with the storage manager 112 in step 904. The updated status file 400 is received by the newly registered device in step 906. The status file 400 is updated to include the new device in step 908 and the data files to be stored in the new device are determined. The storage manager 112 receives the updates and sends the data files to the new device. The data files are received and stored in the new device in step 910.

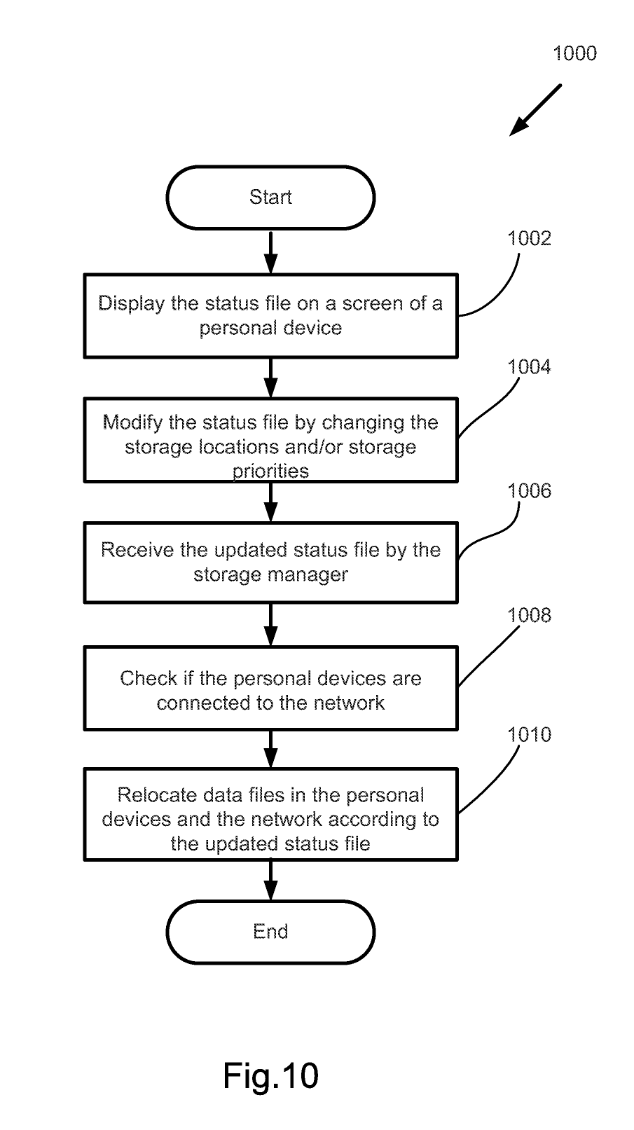

FIG. 10 is flow chart illustrating the operation of the system by employing the status file 400 directly. Process 1000 starts with step 1002 that the status file 400 is displayed on a screen of the personal device. In step 1004, the status file is modified by the user through the input device. The user may modify storage locations for one or more data files. The user may also modify the priority indicators for the data files stored in one or more personal devices. In step 1006, the updated status file is received by the storage manager 112. The storage manager 112 checks which personal devices are connected to the network in step 1008. The data files with changes in locations and priority may be relocated in the personal devices and the network in step 1010. If some of the personal devices are not connected to the network at the moment of checking, the data files stored in the devices will be updated whenever the devices are connected in a later time according to the status file.

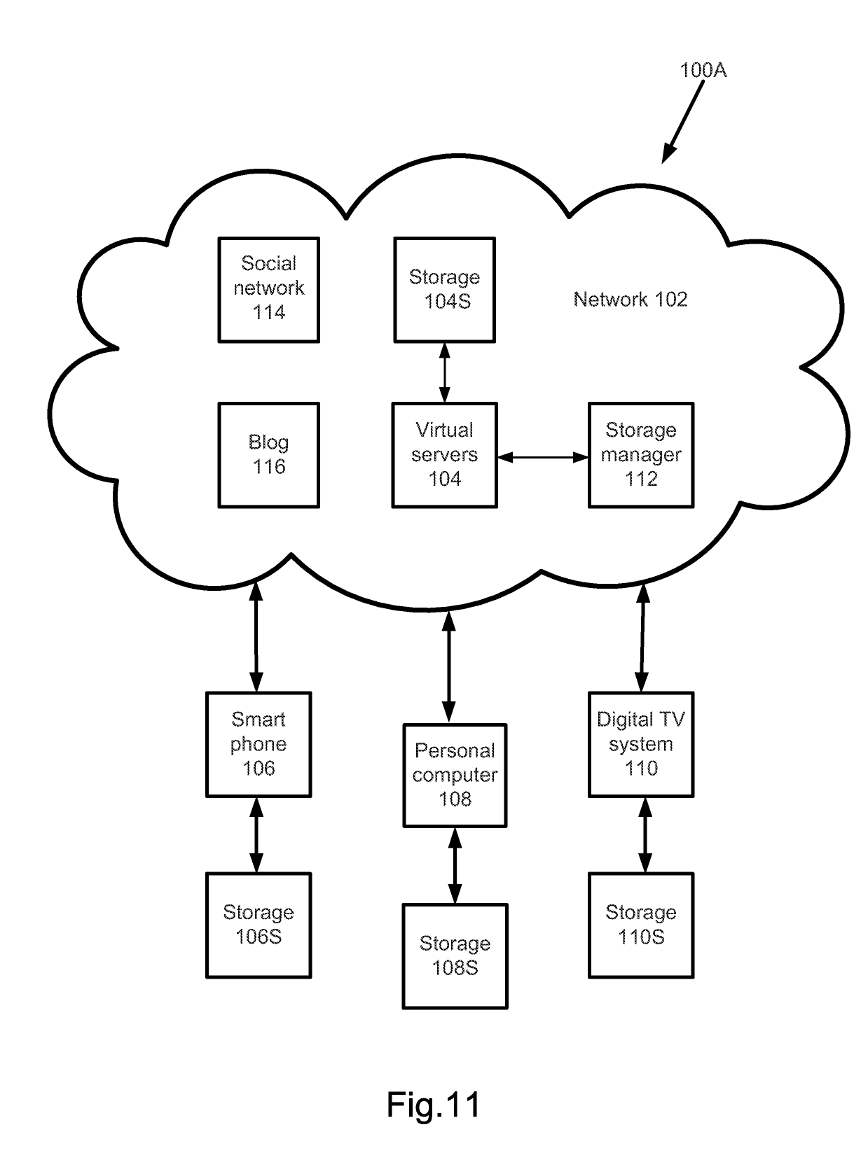

FIG. 11 is a schematic diagram illustrating another implementation of the data storage system. The exemplary system 100A further comprises one or a plurality websites in network 102, such as for example, a social network 114 and a blog 116. The user may upload a personal data file to the websites through the use of the storage manager 112. The user selects the website as one of the storage locations for the data file through the user interface. According to one aspect of the implementation, the user will also need to transmit the user login name and password from one of the personal devices to the storage manager 112 in order that the storage manager can upload the data file to the website on the user's behalf. The uploaded data file may be stored in a storage unit of a server or a virtual storage unit of a virtual server. An authentic checking process is required by the website before the storage manager 112 uploads the data file to the website.

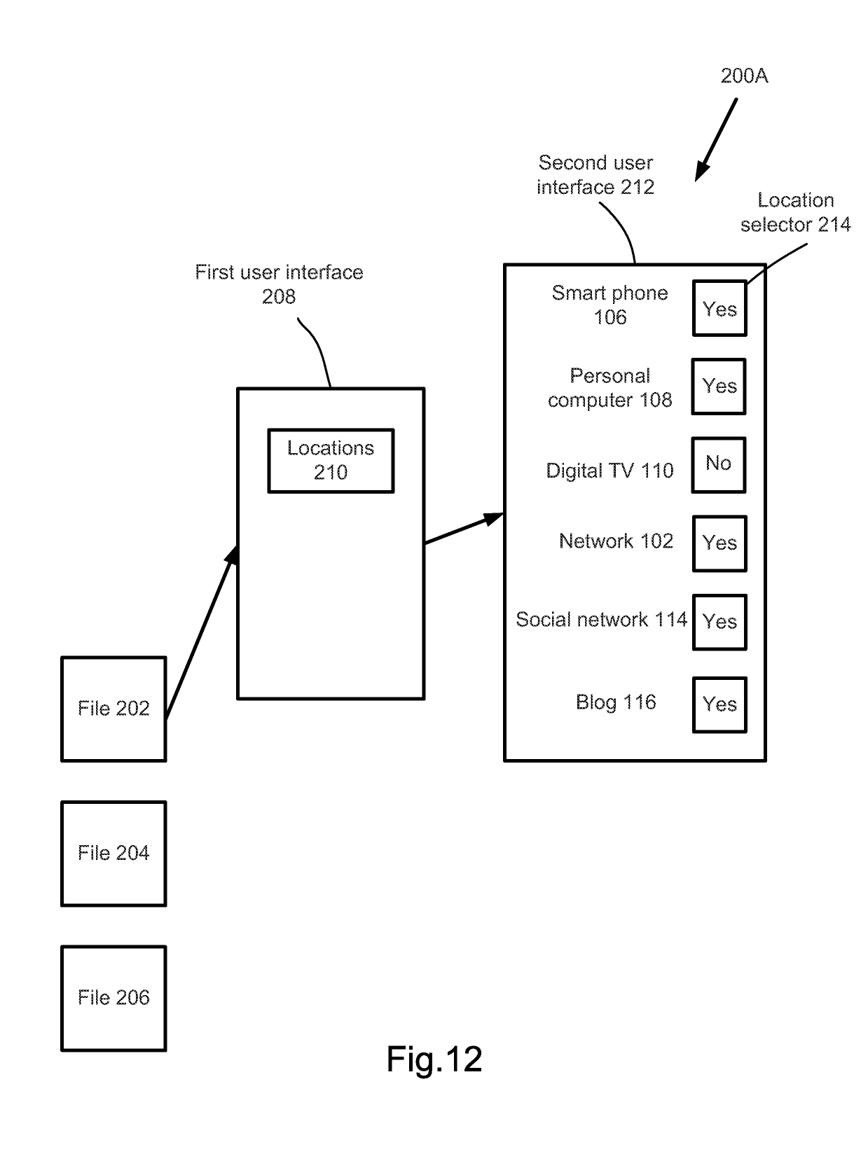

FIG. 12 is a schematic diagram illustrating in an exemplary manner a user interface 200A for selecting the storage locations according to the third embodiment. In an exemplary case, icons representing files: 202, 204 and 206 are displayed on a display window of a personal device. The first user interface 208 associated with the file 202 is displayed exemplarily after the user actuates an input device. In an exemplary case, the personal device is the personal computer 108. The user may move a cursor controlled by a mouse to point the file 202 and then right click the mouse to display the first level interface 208. As well known in the art, the user can select the icon by many different options, such as for example, by touching the icon in a touch-sensitive display. The interface 208 further includes a user selectable icon 210. Upon the user's selection, the second user interface 212 is displayed. The second user interface 212 may further include multiple user selectable storage locations in a location selector 214. One aspect of the third embodiment includes that the second user interface 212 further comprises selectable locations including one or more websites, such as for example, a social network 114 and a blog 116. The user may select one or more locations through the user input device. According to another aspect of the third embodiment, a user may upload a personal data file i.e., a photo to the social network 114 through the use of the storage manager 112. In one implementation, the user may transmit the user's login name and password to the storage manager 112 to allow the personal data file to be uploaded to the selected websites. The implementation as illustrated in the FIG. 12 is exemplary. The location selector 214 may be implemented in various forms as known in the art. Furthermore, the user selectable storage locations may be displayed directly in the first user interface 208. The status file 400 may be updated after the data file is relocated.

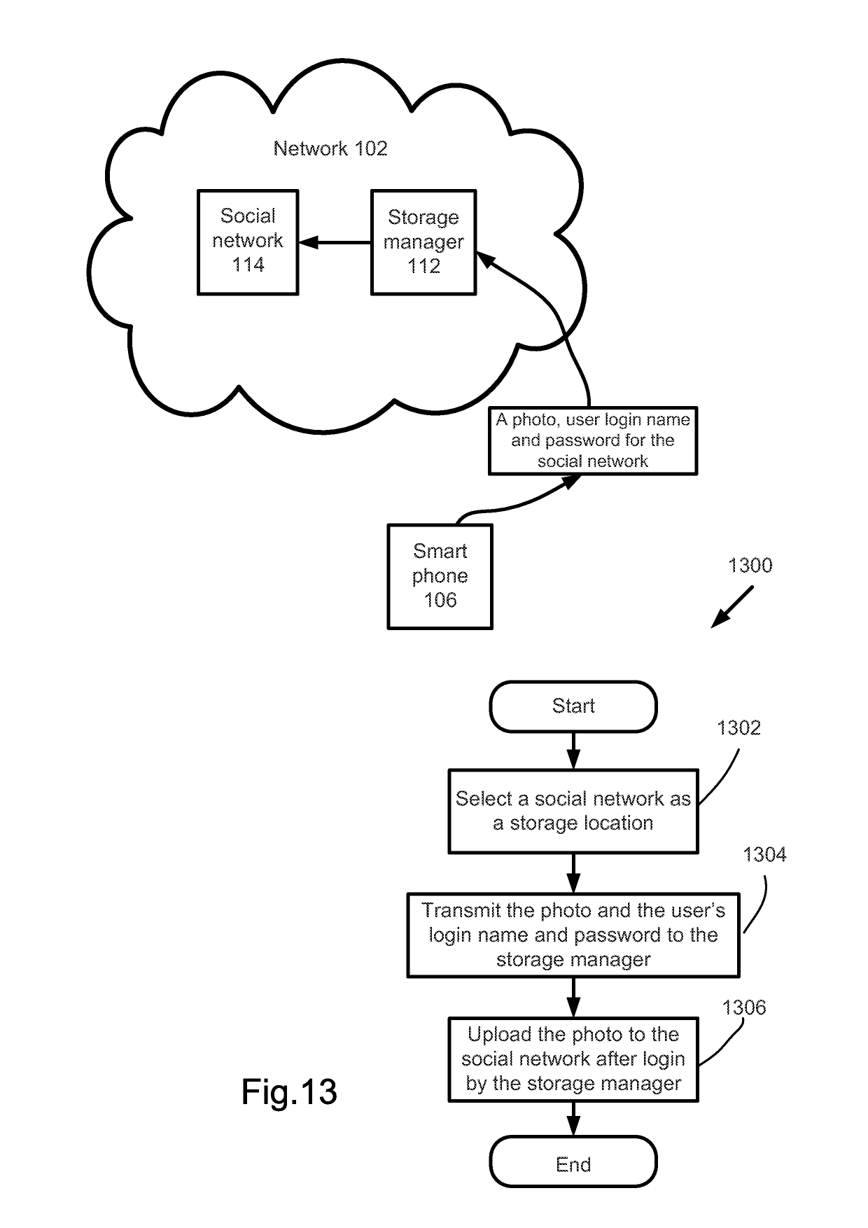

FIG. 13 is a schematic diagram illustrating in an exemplary process 1300 that a personal photo is uploaded to a social network according to the third embodiment of the present invention. The user of smart phone 106 selects through the user interface 200A a social network 114 for storing a personal photo (1302). Upon the user's selection, a processor in smart phone 106 transmits the photo from the smart phone 106 to the storage manager 112 through a communication network (1304). In one implementation, the user's login name and password will need to be transmitted from the smart phone 106 to the storage manager 112. In another implementation, the login name and the password may have already been stored in storage manager 112. Upon receiving the login name and the password, the storage manager 112 uploads the data file to the social network 114 (1306).

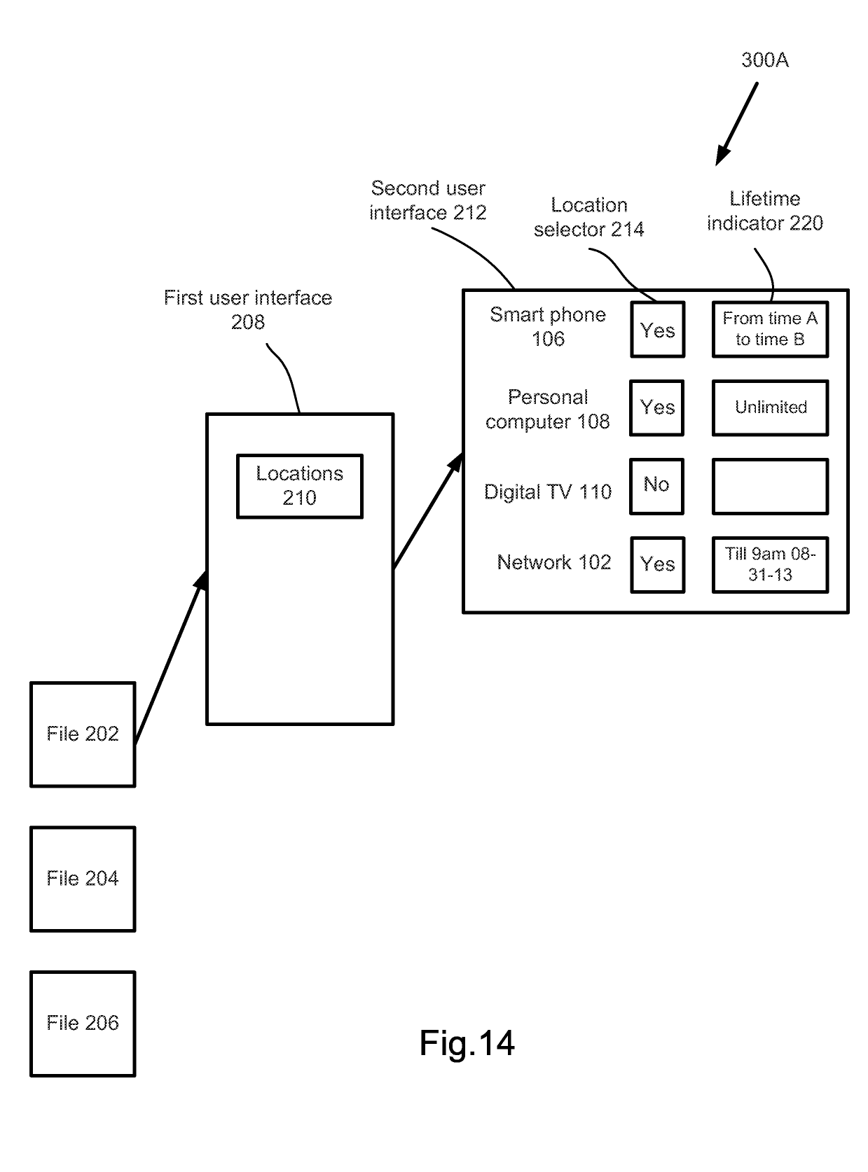

FIG. 14 is a schematic diagram illustrating a user interface 300A for selecting the storage locations according to a fourth embodiment. The fourth embodiment is identical to the first one for the first user interface. The difference is on the second user interface. A lifetime selector 220 is displayed on the second user interface. According to one implementation, lifetime for storing the data file 202 in a specific location (or device) may be keyed in by the user through a user input device. According to another implementation, a calendar may be displayed upon the user's actuation of the input device. The user may select a starting and an ending time for data file 202 for the selected storage location. A default lifetime may be labeled as “unlimited”. After the user's selection, the storage manager 112 relocates the data file among the storage units of the personal devices and the network. When the lifetime for data file 202 is reached in one of the selected locations, storage manager 112 will initiate an operation to remove data file 202 in the storage location. Data file 202 stored in the other devices or in network 102 may be updated before data file 202 is removed. The feature is very useful if the user intends to store data file in a selected storage location for a period of time only. For example, the user may want to store a movie in a personal media device or a personal computer before one is boarded to an airplane. The user may not want to store the data file in the personal device for an unspecified period of time. In another example, the user may want to store a sensitive data file in the cloud so one will have the flexibility to work on the data file from different personal devices. The user may want to remove the file from the cloud after the work is completed.

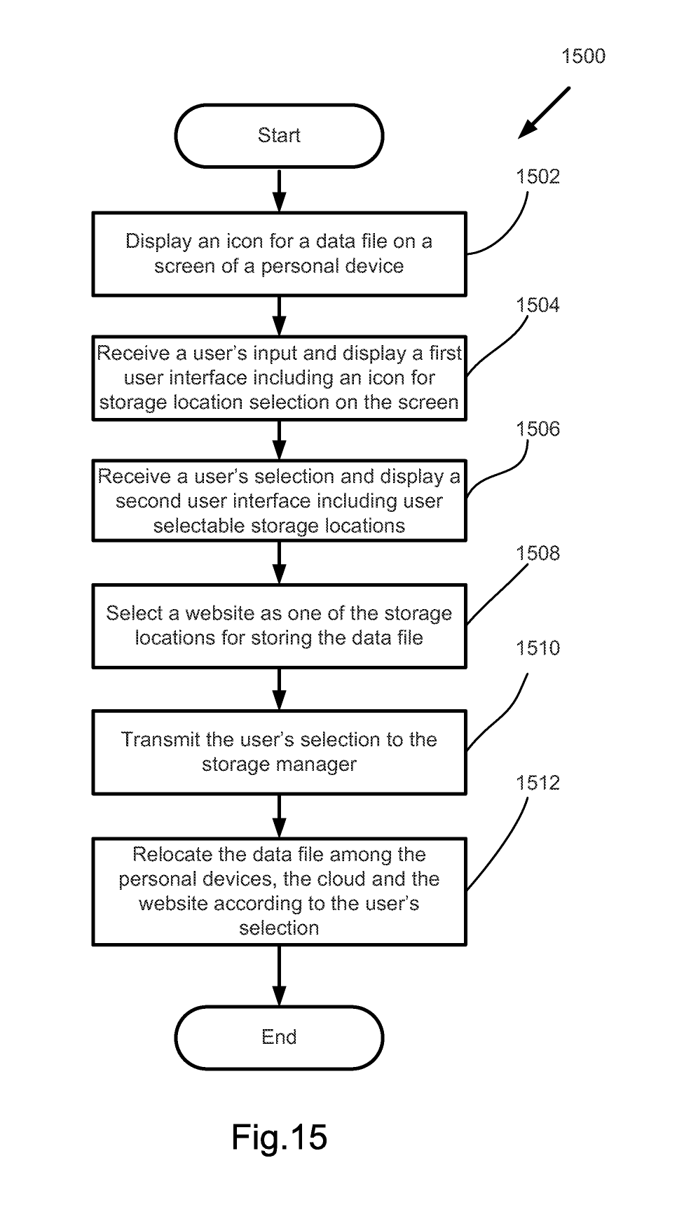

FIG. 15 is a flowchart illustrating the operation of the data storage system according to the third embodiment of the present invention. Process 1500 starts with step 1502 that at least one icon for the data file 202 is displayed on a display screen of a personal device. In step 1504, the user's input action through an input device of the personal device is received. In an exemplary case, a mouse for a personal computer is right-clicked after a cursor is moved to be pointed at the data file. In another exemplary case, the user may touch a touch-sensitive display to make the selection. The first user interface 208 is displayed in a display window. The displayed first user interface 208 includes an icon 210 for selecting the storage locations of the data file. In step 1506, the user's selection of the icon 210 is received by a processor of the personal device. The second user interface 212 including multiple user selectable storage locations is displayed. In an exemplary case, the locations include smart phone 106, personal computer 108, digital TV system 110, the network 102 and the websites such as a social network 114 and blog 116. In step 1508, one or a plurality of storage locations including at least one website are selected by the user through the user input device. In step 1510, the user's selections are transmitted to the storage manager 112. Upon receiving the user's selections, storage manager 112 relocates the data file among the personal devices, the network and the websites. The data file transmitted to the website will be stored in a storage unit of a server or in a virtual storage unit of a virtual server.

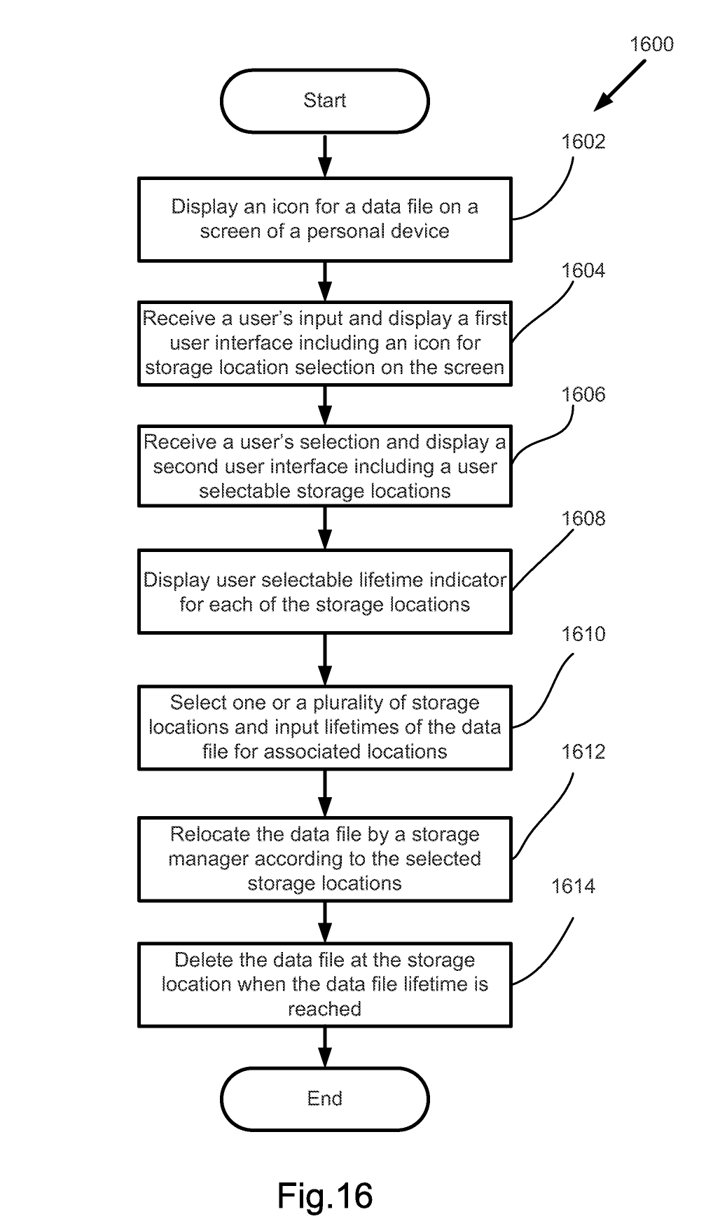

FIG. 16 is a flowchart illustrating the operation of the data storage system according to the fourth embodiment of the present invention. Process 1600 starts with step 1602 that at least one icon for a data file 202 is displayed on a display screen of a personal device. In step 1604, the user's input action through an input device of the personal device is received. In an exemplary case, a mouse for a personal computer is right-clicked after a cursor is moved to point the data file. In another exemplary case, the user touches a touch-sensitive display to make the selection. The first user interface 208 is displayed in a display window. The displayed first user interface 208 includes an icon 210 for selecting the storage locations for the data file 202. In step 1606, the user's selection of the icon 210 is received by a processor of the personal device. The second user interface 212 including multiple user selectable storage locations is displayed. In an exemplary case, the locations include smart phone 106, personal computer 108, digital TV 110 and the network 102. In step 1608, the user selectable lifetime indicator 220 is displayed in the second user interface 212. In step 1610, one or a plurality of storage locations are selected by the user through the user input device. In one implementation, the user keys in the lifetimes for at least some of the storage locations. The user may key in a starting and an ending time. In another implementation, the user may select the lifetimes through a displayed calendar. A default selection may be “unlimited” lifetime for the data file in a local storage unit or in the network. In step 1612, the storage manager 112 relocates the data file among the local storage units of the personal devices and the network storage unit according to received user selections. In step 1614, the storage manager 112 monitors storing time of the data file in each of the personal devices and removes the data file in the specific personal device or in the network if the lifetime of the data file is reached.

1. A system comprises:
a. a plurality of personal devices connectable to a communication network, each of the personal devices including a data storage unit;
b. a network data storage means in said communication network;
c. a plurality of websites, wherein a user's personal data file can be stored in said websites after confirming authenticity of the user by the websites;
d. a user interface, displayable on a proximity of an icon representing the personal data file, for selecting by the user among the personal devices, the network data storage means and the websites for storing the data file; and
e. a storage manager for transferring, storing and removing the data file in the personal devices, the network data storage means and the websites according to the user's inputs through the user interface.

2. The system as recited in claim 1, wherein said user interface further comprising user selectable priority indicators for said data file to be stored in anyone of selected personal devices.

3. The system as recited in claim 2, wherein said priority indicators are utilized to determine if said data file will actually be stored in anyone of the personal devices according to an available storage capacity of the storage unit of the personal device.

4. The system as recited in claim 1, wherein said user interface is displayed after receiving predetermined user's input actions by an input device of the personal device.

5. The system as recited in claim 1, wherein said system further comprising a status file including storage locations and priority indicators of the data files, wherein said status file may be stored in the network or in one or a plurality of the personal devices.

6. The system as recited in claim 5, wherein said status files further comprising data about storage capacity utilization of each of the storage units of the personal devices.

7. The system as recited in claim 1, wherein each of the personal devices further comprising a data file including metadata of the data files stored in the personal devices and in the network.

8. The system as recited in claim 1, wherein said storage manager may be located in one of or a combination of the following locations:
a. a server in the network; and
b. one or a plurality of the personal devices.

9. The system as recited in claim 1, wherein the personal devices including one or more devices from the following group:
a. a smart phone;
b. a portable media player;
c. a personal computer;
d. a HiFi audio system;
e. a digital television system;
f. an automobile media delivery system; and
g. a digital camera.

10. The system as recited in claim 1, wherein said communication network including the Internet.

11. A system comprises:
a. a plurality of personal devices connectable to a communication network, each of the personal devices further including a data storage unit;
b. a network data storage means in said communication network;
c. a user interface, displayable on a proximity of an icon representing a data file, for selecting by a user among the personal devices and the network storage means for storing said data file, wherein said data file further including user selectable lifetimes associated with locations of the data file; and
d. a storage manager for transferring, storing and removing the data files in the personal devices and in the network data storage means according to the user's inputs through the user interface.

12. The system as recited in claim 11, wherein said data file lifetime further including a starting time and an ending time.

13. The system as recited in claim 11, wherein said data file lifetime further including an unlimited time.

14. The system as recited in claim 11, wherein said user interface further comprising user selectable priority indicators for said data file to be stored in anyone of selected personal devices.

15. The system as recited in claim 14, wherein said priority indicators are utilized to determine if said data file will actually be stored in anyone of the personal devices according to an available storage capacity of the storage unit of the personal device.

16. The system as recited in claim 11, wherein said user interface is displayed after receiving predetermined user's input actions by an input device of the personal device.

17. The system as recited in claim 11, wherein said system further comprising a status file including storage locations and priority indicators of the data files, wherein said status file may be stored in the network or in one or a plurality of the personal devices.

18. The system as recited in claim 17, wherein said status file further comprising data about storage capacity utilization of each of the storage units of the personal devices.

19. The system as recited in claim 11, wherein each of the personal devices further comprising a data file including metadata of the data files stored in said personal devices and in the network.

20. A method of storing data files in a plurality of personal devices and in a network, the method comprising:
a. displaying by a processor an icon for a data file on a screen of one of the personal devices;
b. selecting the displayed icon by a user through an input device of the personal device;
c. displaying by the processor a user interface on the screen including user selectable locations for storing the data file and lifetimes of the data file in the locations, wherein said locations further including the personal devices and the network;
d. selecting at least one location by the user through the input device;
e. inputting the lifetime of the data file in selected location;
f. relocating the data file to the selected location (s) by a storage manager in the network; and
g. removing the data file by the storage manager in the location (s) when the lifetime for said data file is reached.
